(19) United States
(12) Patent Application Publication
(10) Pub. No.: US 2026/0135283 A1
(43) Pub. Date: May 14, 2026

(54) DIRECTIONAL COUPLER

(71) Applicant: FURUNO ELECTRIC CO., LTD., Hyogo (JP)

(72) Inventor: Yoshifumi NISHITANI, Nishinomiya (JP)

(73) Assignee: FURUNO ELECTRIC CO., LTD., Hyogo (JP)

(21) Appl. No.: 19/440,961

(22) Filed: Jan. 6, 2026

Related U.S. Application Data
(63) Continuation of application No. PCT/JP2024/024797, filed on Jul. 9, 2024.

(30) Foreign Application Priority Data
Jul. 11, 2023 (JP) 2023-113469

(51) Int. Cl. H01P 5/18

(52) U.S. Cl. CPC H01P 5/184

(57) ABSTRACT

A directional coupler of present invention includes a waveguide, a substrate, two first slits, and two second slits. The substrate is having a strip line and ground layers opposed to each other at a side surface of the waveguide. The two first slits are provided in the side surface of the waveguide along a propagation direction of an electromagnetic waves in the waveguide, and the two second slits are provided in the first ground layer of the substrate opposed to the two first slits.

### CROSS-REFERENCE TO RELATED APPLICATION(S)

This application is a bypass continuation of International Application No. PCT/JP 2024/024797, filed on Jul. 9, 2024, which claims priority to Japanese Patent Application No. 2023-113469, filed on Jul. 11, 2023. The entire contents of the above applications are incorporated herein by reference.

### TECHNICAL FIELD

The present invention relates to a directional coupler.

### BACKGROUND

A conventional directional coupler is a waveguide directional coupler in which the coupling irises are provided in a common wall where the ridges of the first and second waveguides are superposed so as to be orthogonal to each other, wherein a plurality of the coupling irises are provided in any one of the compartments of the common wall separated by the respective ridges of the first and second waveguides, thereby providing a path difference for the electromagnetic waves propagating from the first waveguide in a predetermined direction of the second waveguide.

### SUMMARY

Since the directional coupler is composed of the two waveguides, there is a problem that the directional coupler becomes large. There is also a problem that the cost of the directional coupler increases because the cost of the waveguide is expensive.

The present invention has been made to solve the above-mentioned problems, and an objective of the present invention is to provide a directional coupler capable of realizing cost reduction and miniaturization.

In order to solve the problems described above, a directional coupler, according to an aspect of the present invention, includes a waveguide, a substrate, two first slits, and two second slits. The substrate has a strip line and ground layers opposed to each other at a side surface of the waveguide. The two first slits are provided in the side surface of the waveguide along a propagation direction of the electromagnetic waves in the waveguide. The two second slits are provided in the first ground layer of the substrate opposed to the two first slits.

With such a configuration, the number of waveguides constituting the directional coupler can be reduced in comparison with a case where the directional coupler is composed of two waveguides, and therefore, a directional coupler can be provided, which achieves cost reduction and miniaturization.

In the above aspect of the invention, the substrate may further include a ground region provided on an opposite side of a side surface of the first ground layer of the substrate and provided at a position corresponding to the two second slits.

With such a configuration, leakage of the electromagnetic waves propagating from the waveguide to the strip line through the first and second slits to the outside can be suppressed, and thus a coupling degree in the directional coupler can be improved.

In any of the above aspects of the invention, the substrate may further include a signal line conductor of the strip line provided on the opposite side of the side surface of the first ground layer and extending along the propagation direction, and a width of the signal line conductor at a position corresponding to each position of the two second slits may be larger than a width of the signal line at the positions other than the corresponding positions of the two second slits.

By adjusting the width of the signal line of the strip line in consideration of a positional relationship with the slits provided in the ground layer, it is possible to easily adjust an impedance of the directional coupler when the slits are provided in the ground layer and the dielectric layer of the substrate.

In any of the above aspects of the invention, an area of each of the two second slits may be smaller than an area of each of the two first slits.

With such a configuration, compared with a configuration in which the area of the second slit is the same as the area of the first slit, the intensity of the electromagnetic waves propagating from the waveguide to the strip line can be reduced.

In any of the above aspects of the invention, when an electric length of the transmission path between the two first slits is EL1, an electric length of the transmission path between the two second slits is EL2, and a wavelength of the electromagnetic waves is λ, EL1 and EL2 may satisfy the following equations (1) and (2), respectively:

$$EL 1 = λ / 4 \qquad ( 1 )$$

$$EL 2 = ( 1 / 4 + 1 / 2 \times N ) \times λ \qquad ( 2 )$$

where N is an integer.

With such a configuration, a phase of the electromagnetic waves traveling on one path can be made to be an opposite phase of a phase of the electromagnetic waves traveling on the other path by the difference between an electric length of the path in which the electromagnetic waves branched in the waveguide travel through the signal line of the strip line passing through one of the two first slits and the corresponding second slit and the electric length of the path in which the electromagnetic waves travel through the signal line passing through the other of the two first slits and the corresponding second slit and reach the second slit. Thus, the electromagnetic waves propagating in one direction of the signal line can be canceled in the second slit, and the directionality of the electromagnetic waves can be realized in the directional coupler.

According to the present invention, it is possible to provide a directional coupler that achieves low cost and miniaturization.

### BRIEF DESCRIPTION OF DRAWINGS

FIG. 1 is a perspective view schematically showing a configuration of a directional coupler according to an embodiment of the present invention.

FIG. 2 is a plan view schematically showing a configuration of a waveguide according to an embodiment of the present invention.

FIG. 3 is a cross-sectional view showing a cross-section along the line III-III in FIG. 2 of the waveguide according to an embodiment of the present invention.

FIG. 4 is a plan view schematically showing a structure of a substrate according to an embodiment of the present invention.

FIG. 5 is a cross-sectional view showing a cross-section along the V-V line in FIG. 4 of the substrate according to an embodiment of the present invention.

FIG. 6 is a plan view schematically showing a configuration of a first ground layer of the substrate according to an embodiment of the present invention.

FIG. 7 is a view for explaining a shape of a signal line conductor included in the substrate according to an embodiment of the present invention.

FIG. 8 is a diagram for explaining a directionality of the electromagnetic waves in the directional coupler according to an embodiment of the present invention.

FIG. 9 is a diagram for explaining the directionality of the electromagnetic waves in the directional coupler according to an embodiment of the present invention.

### DETAILED DESCRIPTION

The embodiments of the present invention will now be described with reference to the drawings. In the present specification and the figures, elements like those described above with respect to the previous figures may be denoted by the same reference numerals, and detailed descriptions may be omitted accordingly. In addition, at least one of the following embodiments may be optionally combined.

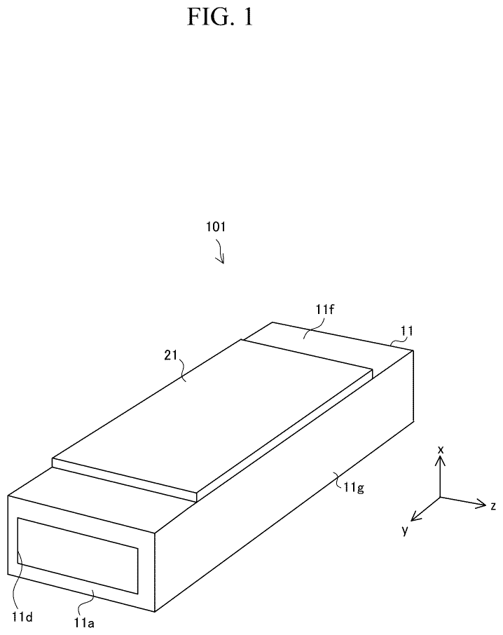

FIG. 1 is a perspective view schematically showing a configuration of a directional coupler according to an embodiment of the present invention. Referring to FIG. 1, the directional coupler 101 includes a waveguide 11 and a substrate 21. The substrate 21 is fixed to the waveguide 11, for example, by a fixing member such as a screw.

The directional coupler 101 is provided, for example, in a radar device for monitoring a moving object on water, such as a ship. Specifically, for example, the directional coupler 101 is provided in the radar apparatus for extracting a part of the electromagnetic waves E transmitted from a transmitter as electromagnetic waves for power monitoring.

### Waveguide

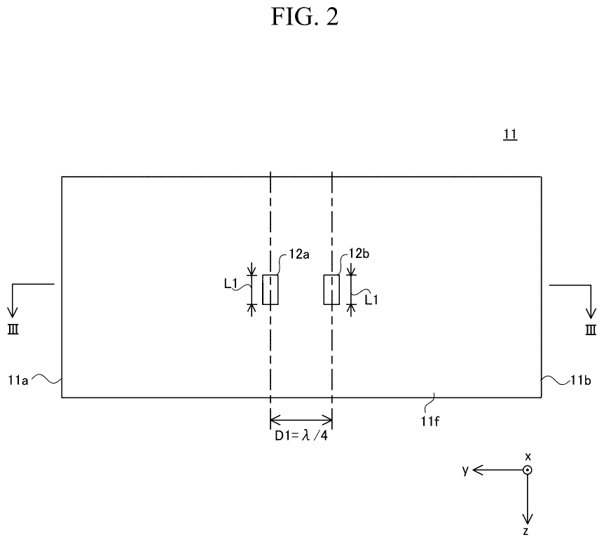

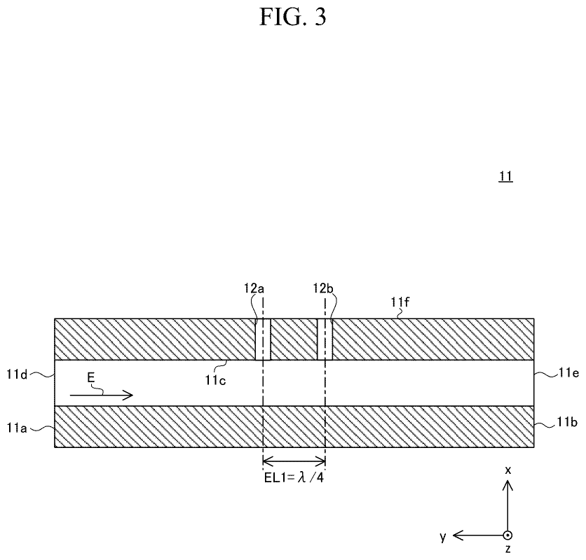

FIG. 2 is a plan view schematically showing a configuration of a waveguide according to an embodiment of the present invention. FIG. 3 is a cross-sectional view showing a cross-section along the line III-III in FIG. 2 of the waveguide according to an embodiment of the present invention. Referring to FIGS. 1 to 3, the waveguide 11 propagates the electromagnetic waves E. Specifically, for example, the waveguide 11 propagates the electromagnetic waves in an X-band (X-band: 8 GHz to 12 GHz).

The waveguide 11 is, for example, a square waveguide. The waveguide 11 has a first end portion 11a, a second end portion 11b, and a cavity 11c. The cavity 11c extends in a longitudinal direction of the waveguide 11.

The first end portion 11a and the second end portion 11b have openings 11d and 11e, respectively. The openings 11d and 11e form a part of the cavity 11c.

A y-axis is defined as an axis parallel to the longitudinal direction of the waveguide 11 and oriented from the second end portion 11b to the first end portion 11a of the waveguide 11. An x-axis is defined as an axis perpendicular to the y-axis. The x-axis is oriented vertically upward, for example. The axis perpendicular to the x-and y-axes is defined as a z-axis. The z-axis has an orientation such that the x-axis, the y-axis and the z-axis form a coordinate axis of a right-hand system.

For example, in a plane perpendicular to the longitudinal direction of the waveguide 11, that is, in an xz-plane, the cross-section of the waveguide 11 is rectangular. In the waveguide 11, a side surface including a long side of the rectangle is an H-plane 11f, and a side surface including a short side of the rectangle is an E-plane 11g.

For example, in the H-plane 11f of the waveguide 11, two first slits 12a and 12b are provided along the propagation direction of the electromagnetic waves in the waveguide 11, i.e., the y-axis direction.

For example, the first slits 12a and 12b have a long rectangular shape in the z-axis direction in a plan view. The first slits 12a and 12b may have other shapes, such as a circular shape in the plan view.

In the present embodiment, for example, a size and a shape of the first slit 12a are the same as those of the first slit 12b. The size and shape of the first slit 12a may be different from those of the first slit 12b.

When an electric length of the transmission path between the first slit 12a and the first slit 12b is EL1 and a wavelength of the electromagnetic waves E propagating through the waveguide 11 is λ, the relationship between the electric length EL1 and the wavelength λ is expressed by Equation (1) below.

$$EL 1 = λ / 4 \qquad ( 1 )$$

For example, the electric length EL1 is set by adjusting the length of the waveguide 11 in the longitudinal direction.

At least one of the first slit 12a and the first slit 12b may be provided so as to be shifted in the z-axis direction on the H-plane 11f. In the waveguide 11, the two first slits 12a and 12b may be provided on the E-plane 11g instead of the H-plane 11f.

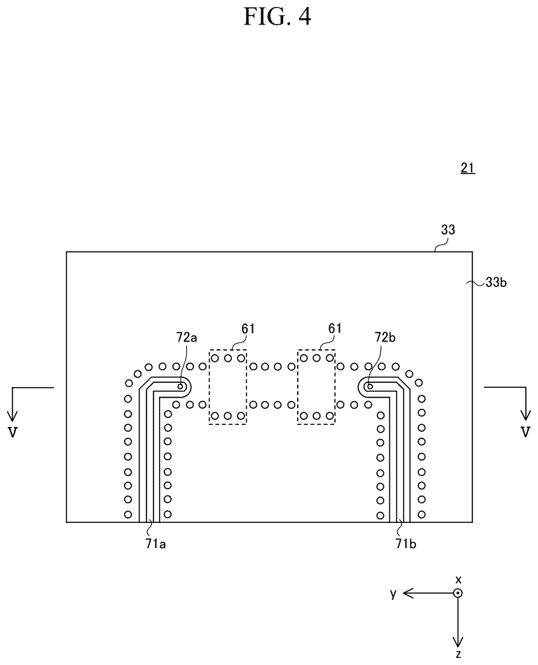

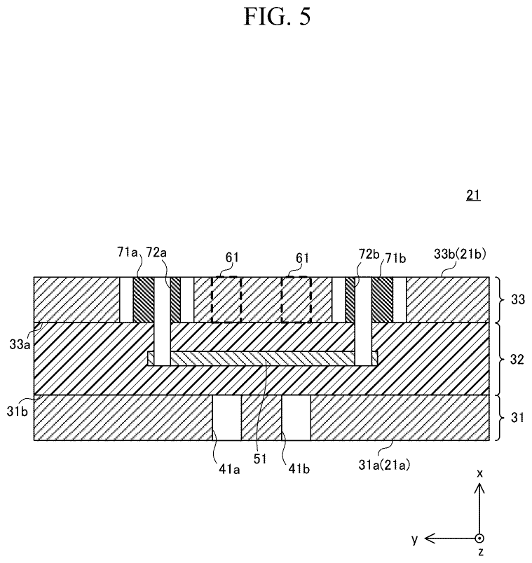

FIG. 4 is a plan view showing a structure of a substrate according to an embodiment of the present invention. FIG. 5 is a cross-sectional view showing a cross-section along the V-V line in FIG. 4 of the substrate according to an embodiment of the present invention. Referring to FIGS. 1, 4, and 5, the substrate 21 is, for example, a printed wiring board. The substrate 21 has a first main surface 21a facing the waveguide 11 and a second main surface 21b provided on the opposite side of the first main surface 21a.

The substrate 21 includes a first ground layer 31, a dielectric layer 32, and a second ground layer 33. The first ground layer 31, the dielectric layer 32, and the second ground layer 33 are laminated in this order from the side of the first main surface 21a of the substrate 21.

The first ground layer 31 faces the H-plane 11f of the waveguide 11 in the stacking direction. The surface (hereinafter also referred to as “facing surface”) 31a facing the H-plane 11f of the first ground layer 31 constitutes the first main surface 21 a of the substrate 21. The first ground layer 31 is generally provided over the entire surface of the substrate 21 in a plan view (hereinafter, it is also referred to simply as'plane view) with a yz plane viewed from above. The first ground layer 31 is a thin conductor such as, for example, copper foil.

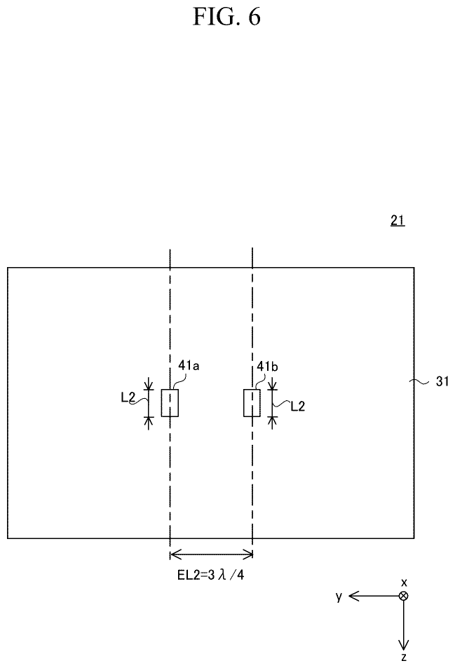

FIG. 6 is a plan view schematically showing a structure of the first ground layer of the substrate according to an embodiment of the present invention. Referring to FIGS. 5 and 6, the first ground layer 31 is provided with two second slits 41a and 41b opposed to the two first slits 12a and 12b shown in FIG. 2.

Specifically, for example, in the first ground layer 31, the two second slits 41a and 41b are provided at positions overlapping the two first slits 12a and 12b in the plan view. The second slits 41a, 41b penetrate the first ground layer 31.

For example, the second slits 41a, 41b have a long rectangular shape in a z-axis direction in the plan view. The second slits 41a and 41b may have other shapes such as a circular shape in the plan view.

In the present embodiment, for example, a size and a shape of the second slit 41a are the same as those of the second slit 41b. The size and shape of the second slit 41a may be different from those of the second slit 41b.

Referring to FIGS. 2 and 6, an area A2 of each of the two second slits 41a and 41b is smaller than an area A1 of each of the two first slits 12a and 12b.

Specifically, for example, a length L2 of each of the two second slits 41a and 41b in a z-axis direction is smaller than a length L1 of each of the two first slits 12a and 12b in a z-axis direction. As a result, the area A2 is smaller than the area A1. The area A2 may be the same as the area A1.

Referring again to FIG. 5, the dielectric layer 32 is disposed between the first ground layer 31 and the second ground layer 33 to insulate the first ground layer 31 and the second ground layer 33. The dielectric layer 32 is generally provided over the entire area of the substrate 21 in the plan view. The material of the dielectric layer 32 is, for example, glass epoxy resin.

The second ground layer 33 is located on the side of the surface 31b opposite to the side surface 31a of the first ground layer 31. The second ground layer 33 constitutes the second main surface 21b of the substrate 21. The second ground layer 33 is generally provided over the entire area of the substrate 21 in the plan view. The second ground layer 33 is a thin conductor such as, for example, copper foil.

Referring again to FIG. 5, the first ground layer 31, the dielectric layer 32, and the second ground layer 33 in the substrate 21 constitute a strip line.

In the present embodiment, a signal line conductor 51, which is the signal line S of the strip line, is formed inside the dielectric layer 32. That is, the substrate 21 includes the signal line conductor 51 provided on an opposite side of the surface (hereinafter also referred to as “facing surface”), 31 a facing the H-plane 11f of the first ground layer 31.

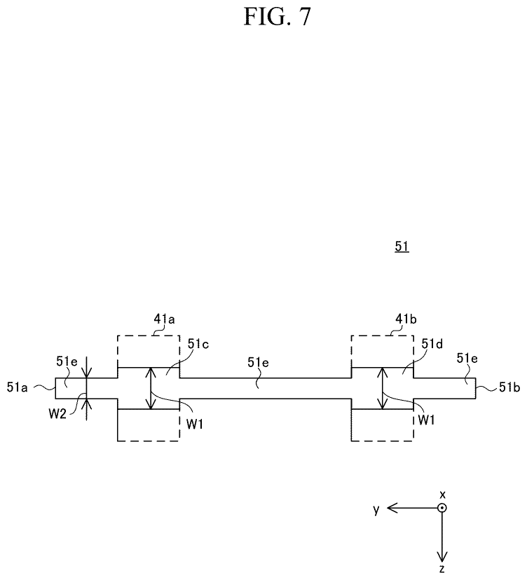

FIG. 7 is a diagram for explaining a shape of the signal line conductor included in the substrate according to an embodiment of the present invention.

Referring to FIG. 7, the signal line conductor 51 extends along the propagation direction of the electromagnetic waves E in the waveguide 11, i.e., the y-axis direction. The signal line conductor 51 has a first end portion 51a and a second end portion 51b.

When a width of the signal line conductor 51 at the positions corresponding to the positions of the two second slits 41a and 41b (hereinafter also referred to as “corresponding positions P1”) is W1 and a width of the signal line conductor 51 at the positions P2 other than the corresponding positions P1 is W2, the width W1 is larger than the width W2.

Specifically, for example, the corresponding positions P1 correspond to the positions of the regions 51c and 51d in the signal line conductor 51 that overlap the second slits 41a and 41b in a plan view, respectively. The positions P2 correspond to the positions of the regions 51e other than the regions 51c and 51d in the signal line conductor 51, that is, the regions 51e that do not overlap the second slits 41a and 41b in the plan view.

Referring again to FIGS. 4 and 5, for example, the substrate 21 includes a ground region 61 provided on the opposite side of the side surface 31a in the first ground layer 31 and provided at a position corresponding to the two second slits 41a and 41b. In the present embodiment, the ground region 61 forms a part of the second ground layer 33.

Specifically, for example, in the second ground layer 33, the ground region 61 is provided at a position overlapping the two second slits 41a and 41b in the plan view.

### Electrical Length of the Transmission Line Between the Second Slits 41a and 41b

When an electric length of the transmission path between the second slit 41a and the second slit 41b is EL2, the relationship between the electric length EL2 and the wavelength λ of the electromagnetic waves E is expressed by Equation (2) below. In Equation (2), N is an integer.

$$EL 2 = ( 1 / 4 + 1 / 2 \times N ) \times λ \qquad ( 2 )$$

For example, the electric length EL2 is set by adjusting the dielectric constant of the dielectric layer 32. Alternatively, for example, the electric length EL2 is set by providing a meander line between the second slits 41a and 41b. In this embodiment, the electric length EL2 is 3λ/4.

### Directionality of Electromagnetic Waves

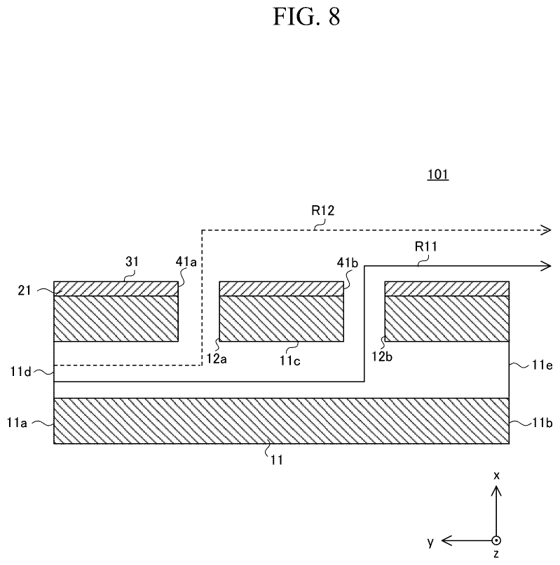

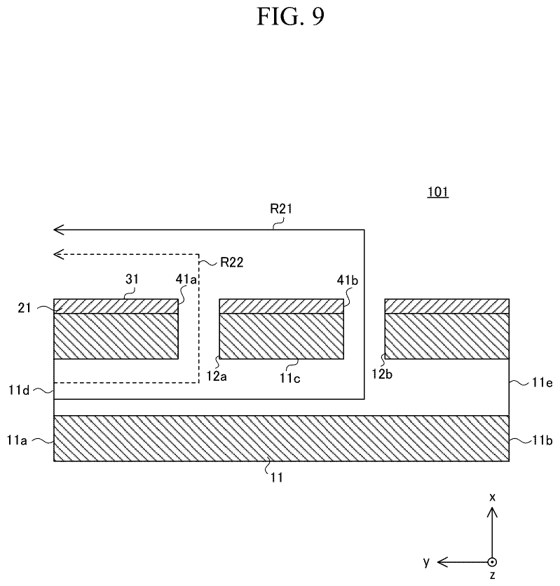

FIGS. 8 and 9 are diagrams for explaining a directionality of the electromagnetic waves in a directional coupler according to an embodiment of the present invention.

Referring to FIGS. 8 and 9, in the waveguide 11, the opening 11d at the first end 11a constitutes an input port of the directional coupler 101, and the opening 11e at the second end 11b constitutes an output port of the directional coupler 101.

FIG. 8 is a diagram for explaining a phase difference between a path length T11 when the electromagnetic waves E branched in the waveguide 11 travels a path R11 and a path length T12 when it travels a path R12.

The path R11 is a path in which the electromagnetic waves E propagating from the first end portion 11a to the second end portion 11b branches, passes through the first slit 12b in the waveguide 11 and the second slit 41b in the first ground layer 31, and propagates in the negative direction of a y-axis through the signal line conductor 51 shown in FIG. 7. The path R12 is a path in which the electromagnetic waves E propagating from the first end portion 11a to the second end portion 11b branches, passes through the first slit 12a and the second slit 41a, and propagates in the negative direction of the y-axis through the signal line conductor 51.

When the electromagnetic waves E travels the path R11, the path length T11 is the sum of the electric length EL0 of the transmission path between the opening portion d and the first slit 12a in the waveguide 11, the electric length EL1 of the transmission path between the two first slits 12a and 12b, and the electric length EL10 of the transmission path between the region 51d and the second end portion 51b in the signal line conductor 51 shown in FIG. 7.

When the electromagnetic waves E travels the path R12, the path length T12 is the sum of the electric length EL0, the electric length EL2 of the transmission path between the two second slits 41a and 41b, and the electric length EL10.

As expressed by the aforementioned equations (1) and (2), the electric length EL1 and the electric length EL2 are λ/4 and 3λ/4, respectively. Therefore, the absolute value of the difference between the path length T11 and the path length T12, that is, the phase difference between the phase of the electromagnetic waves E traveling on the path R11 and the phase of the electromagnetic waves E traveling on the path R12, is λ/2. In this case, since the electromagnetic waves E traveling on the path R11 and the electromagnetic waves E traveling on the path R12 cancel each other, the electromagnetic waves E is not extracted from the directional coupler 101.

FIG. 9 is a diagram for explaining the phase difference between the path length T21 when the electromagnetic waves E branched in the waveguide 11 travel on the path R21 and the path length T22 when it travels on the path R22.

The path R21 is a path in which the electromagnetic waves E propagating from the first end portion 11a to the second end portion 11b branches pass through the first slit 12b in the waveguide 11 and the second slit 41b in the first ground layer 31, and propagate in the positive direction of the y-axis through the signal line conductor 51 shown in FIG. 7. The path R22 is a path in which the electromagnetic waves E propagating from the first end portion 11a to the second end portion 11b branches, pass through the first slit 12a and the second slit 41a and propagate in the positive direction of the y-axis through the signal line conductor 51.

When the electromagnetic waves E travel the path R21, the path length T21 is the sum of the electric length EL1 and the electric length EL2, that is, λ. When the electromagnetic waves E travel the path R22, the path length T22 is the wavelength λ of the electromagnetic waves E.

The phase difference between the path length T21 and the path length T22 is 0. In this case, since the electromagnetic waves E traveling in the path R21 and the electromagnetic waves E traveling in the path R22 are in the same phase, the electromagnetic waves E are extracted from the directional coupler 101.

Referring again to FIG. 4, two signal line conductors 71a and 71b and two via holes 72a and 72b are provided on the surface 33b opposite to the surface 33a facing the dielectric layer 32 in the second ground layer 33.

In the present embodiment, the signal line conductor 71a constitutes a coupling port of the directional coupler 101, and the signal line conductor 71b constitutes an isolation port of the directional coupler 101.

The via hole 72a electrically connects the signal line conductor 51 and the signal line conductor 71a. The via hole 72b electrically connects the signal line conductor 51 and the signal line conductor 71b. The electromagnetic waves E propagating through the signal line conductor 51 propagate through the via hole 72a to the signal line conductor 71a. The signal line conductor 71a propagates the electromagnetic waves E acquired by the directional coupler 101 to a monitoring device (not shown).

In order to monitor the power of the electromagnetic waves E transmitted from the transmitter in the radar device, for example, the electromagnetic waves for power monitoring may be extracted through a pin fixed to the waveguide. However, in this case, since the directionality of the electromagnetic waves extracted by the pin is not secured, there is a problem that the power value under monitoring fluctuates due to load fluctuation. In addition, there is a problem that the cost of the coaxial connector, including the pin is expensive.

In the radar apparatus, a directional coupler, including two waveguides, may be used to extract electromagnetic waves for power monitoring. In this case, since the directional coupler is composed of two waveguides, there is a problem that the directional coupler becomes large. There is also a problem that the cost of the directional coupler increases because the cost of the waveguide is expensive.

On the other hand, the directional coupler 101, according to the embodiment of the present invention, can be reduced in cost and miniaturized by the above configuration.

The scope of the present disclosure is indicated by the claims rather than the above description, and all modifications are intended to be included within the meaning and scope equivalent to the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can”, “could”, “might” or “may” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations, or two or more recitations).

It will be understood by those within the art that, in general, terms used herein, are generally intended as “open” terms (e.g., the term “including” should be interpreted as “including but not limited to” the term “having” should be interpreted as “having at least” the term “includes” should be interpreted as “includes but is not limited to” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above”, “below”, “bottom”, “top”, “side”, “higher”, “lower”, “upper”, “over” and “under” are defined with respect to the horizontal plane.

As used herein, the terms “attached”, “connected”, “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about” and “substantially” as used herein include the recited numbers, and also represent an amount close to the stated amount that still performs a desired function or achieves a desired result. For example, the terms “approximately”, “about” and “substantially” may refer to an amount that is within less than 10% of the stated amount. Features of embodiments disclosed herein preceded by a term such as “approximately”, “about” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### REFERENCE SIGNS LIST

11: Waveguide, 11a: First End, 11b: Second End, 11c: Cavity, 11d: Opening, 11e: Opening, 11f: H-plane, 11g: E-plane, 12a, 12b: First Slit, 21: Substrate, 21a: First Main Surface, 21b: Second Main Surface, 31: First Ground Layer, 31a, 31b, 33a, 33b: Surface, 32: Dielectric Layer, 33: Second Ground Layer, 41a, 41b: Second Slit, 51: Signal Line Conductor, 51a: First End Portion, 51b: Second End Portion, 51c, 51d, 51e: Regions, 61: Ground Region, 71a, 71b: Signal Line Conductor, 72a, 72b: Via Hole, 101: Directional Coupler, E: Electromagnetic Waves, EL1, EL2: Electrical Length, λ: Wavelength

What is claimed is:

1. A directional coupler, comprising:
a waveguide,
a substrate,
two first slits, and
two second slits,
wherein:
the substrate has a strip line and ground layers opposed to each other at a side surface of the waveguide,
the two first slits are provided in the side surface along a propagation direction of the electromagnetic waves in the waveguide, and
the two second slits are provided in the first ground layer of the substrate opposed to the two first slits.

2. The directional coupler of the claim 1, wherein:
the substrate is further comprising:
a ground region
provided on an opposite side of a side surface of the first ground layer and
provided at a position corresponding to the two second slits.

3. The directional coupler of the claim 1, wherein:
the substrate is further comprising:
a signal line conductor of the strip line
provided on the opposite side of the side surface of the first ground layer and
extending along the propagation direction, wherein:
a width of the signal line conductor at a position corresponding to each position of the two second slits is larger than a width of the signal line at the positions other than the corresponding positions of the two second slits.

4. The directional coupler of the claim 2, wherein:
the substrate is further comprising:
a signal line conductor of the strip line
provided on the opposite side of the side surface of the first ground layer and
extending along the propagation direction, wherein:
a width of the signal line conductor at a position corresponding to each position of the two second slits is larger than a width of the signal line at the positions other than the corresponding positions of the two second slits.

5. The directional coupler of the claim 3, wherein:
an area of each of the two second slits is smaller than an area of each of the two first slits.

6. The directional coupler of the claim 4, wherein:
an area of each of the two second slits is smaller than an area of each of the two first slits.

7. The directional coupler of claim 5, wherein:
EL1 and EL2 satisfy the following equations (1) and (2), respectively:
$$EL 1 = λ / 4 \qquad ( 1 )$$
$$EL 2 = ( 1 / 4 + 1 / 2 \times N ) \times λ \qquad ( 2 )$$
where N is an integer
when
an electric length of a transmission path between the two first slits is EL1,
an electric length of a transmission path between the two second slits is EL2, and
a wavelength of the electromagnetic waves is λ.

8. The directional coupler of claim 6, wherein:
EL1 and EL2 satisfy the following equations (1) and (2), respectively:
$$EL 1 = λ / 4 \qquad ( 1 )$$
$$EL 2 = ( 1 / 4 + 1 / 2 \times N ) \times λ \qquad ( 2 )$$
where N is an integer
when
an electric length of a transmission path between the two first slits is EL1,
an electric length of a transmission path between the two second slits is EL2, and
a wavelength of the electromagnetic waves is λ.
